(19) United States
(12) Patent Application Publication
(10) Pub. No.: US 2006/0122355 A1
(43) Pub. Date: Jun. 8, 2006

(54) Derivatized highly branched polysaccharide and a mix for production of polyurethane thereof

(76) Inventors: James O'Connor, Cheshire, CT (US); Charles Nichols, Terre Haute, IN (US); Kenneth Knoblock, Terre Haute, IN (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/250,236

(22) Filed: Oct. 14, 2005

Related U.S. Application Data
(60) Provisional application No. 60/618,958, filed on Oct. 15, 2004.
(60) Provisional application No. 60/619,109, filed on Oct. 15, 2004.

(51) Int. Cl. C08G 18/00

(52) U.S. Cl. 528/44

(57) ABSTRACT

The invention relates to a highly branched polysaccharide which is derivatized to provide a hydrophobicity which renders it compatible with a polyether polyol with which the underivatized polysaccharide is incompatible. Further the invention relates to a mix for the production of polyurethane. The mix comprises a mixture of the derivatized polysaccharide and a polyether polyol. The polysaccharide of the mix is derivatized to provide a hydrophobicity which renders it compatible with a polyether polyol with which the underivatized polysaccharide is incompatible. The derivatized highly branched polysaccharide used in the invention has an active hydrogen functionality of at least 15 and comprises randomly bonded glucopyranose units, having an average number of 10-100 glucose residues.

This application claims priority Under 35 U.S.C §119(e) of U.S. provisional patent application Ser. No. 60/618,958, entitled “Foamed Isocyanate-based Polymer, a Mix and Process for Production Thereof”, filed Oct. 15, 2004, the complete disclosure of which is hereby incorporated by reference for all purposes.

The invention relates to a highly branched polysaccharide which is derivatized to provide a hydrophobicity which renders it compatible with a polyether polyol with which the underivatized polysaccharide is incompatible. Further the invention relates to a mix for the production of polyurethane. The mix comprises a mixture of the derivatized polysaccharide and a polyether polyol. The polysaccharide of the mix is derivatized to provide a hydrophobicity which renders it compatible with a polyether polyol with which the underivatized polysaccharide is incompatible. The derivatized highly branched polysaccharide used in the invention has an active hydrogen functionality of at least 15 and comprises randomly bonded glucopyranose units, having an average number of 10-100 glucose residues.

### BACKGROUND OF THE INVENTION

Polysaccharides can be used in polyurethanes which are prepared by reacting an organic isocyanate with a polyol in the presence of additional components like catalysts, surfactants etc. When preparing polyurethane foams a blowing agent is usually added.

Carbohydrates are known as initiators in the production of polyether polyols or as direct additives to a polyol or blend of polyols as part of the polyurethane formulation. Simple carbohydrates such as sucrose, sorbitol, fructose and glucose have been used to initiate polyether polyols designed to facilitate solely water blown rigid foams as described in U.S. Pat. No. 5,690,855. U.S. Pat. No. 5,185,383 uses hexoses as a polyol starter and U.S. Pat. No. 4,943,597 describes a polyol composition wherein simple carbohydrates such as dextrose, sorbitol, sucrose, alpha-methylglucoside and alpha-hydroxyethylglucoside are suitable initiators for a high molecular weight, high functionality polyol which can be used to make substantially water-blown rigid foams.

More complex carbohydrate units such as cellulose and starches have also been employed in the production of polyurethanes as described in U.S. Pat. No. 4,520,139. Complex carbohydrate units such as pectins, starch or other amylaceous materials may be used in foaming systems with or without an auxiliary blowing agent. The starches may be modified prior to use. Thus in U.S. Pat. No. 4,401,772 methyl glucoside is formed by an acid catalyzed reaction with starch. This is then reacted with a suitable amine and an alkylene oxide to form a polyether polyol. More recently a jet-cooked starch oil composite has been used in conjunction with low molecular weight glycol polyol to make a polyurethane foam with altered characteristics, as described in R. L. Cunningham, et al. J. Appl. Polym. Sci. 69: 957, 1998. Unmodified cellulose and starches, and polysaccharides have also been converted to polyurethane precursors by alkoxylation and more specifically propoxylation. Formation of polyether polyols resulted in compounds useful as precursors for fat mimetics in U.S. Pat. No. 5,273,772, and in rigid and flexible polyurethanes foams in U.S. Pat. No. 4,585,858. In the process of U.S. Pat. No. 5,273,772, involving carbohydrates capable of having more complex, highly branched and random glucosidic linkages, water must be rigorously removed prior to alkoxylation. The composition of U.S. Pat. No. 4,585,858 can tolerate about 15-23% water when crude starch is one of the initiators, however the document specifically refers to starch—meaning compounds with 1,4 glucosidic linkages derived from any vegetable source with and without chemical modification.

As direct additives untreated carbohydrates have been incorporated into polyurethane foams in two ways—1) as a partial or complete replacement for the polyol component, and 2) as an unreacted additive or filler. The carbohydrate can be introduced into the foam starting materials either as a solution or as a fine solid. When added as a solution, the hydroxyl groups on the carbohydrate can react with the isocyanate component and become chemically incorporated into the structure of the polyurethane. Examples of carbohydrates include certain starches, corn syrup, cellulose, pectin as described in U.S. Pat. No. 4,520,139, mono- and disaccharides as described in U.S. RE31,757, U.S. Pat. Nos. 4,400,475, 4,404,294, 4,417,998, oligosaccharides as described in U.S. Pat. No. 4,404,295 and pregelatinized starch as described in U.S. Pat. No. 4,197,372. As a solid dispersion, the carbohydrate may be inert in the polymerization reaction, but is physically incorporated into the foam. The advantage is lower cost and the ability of the carbohydrates to char upon combustion, preventing further burning and/or dripping of the foam and reducing smoke formation as described in U.S. Pat. Nos. 3,956,202, 4,237,182, 4,458,034, 4,520,139, 4,654,375. Starch and cellulose are commonly used for this purpose. The starch or cellulose may also be chemically modified prior to foam formulation as described in U.S. Pat. Nos. 3,956,202 and 4,458,034. Use of a dendritic macromolecule in isocyanate based foams are described in U.S. Pat. No. 5,418,301, WO 02/10189 and US Applications US 2003/0236315 and US 2003/0236316 and the use of highly branched polysaccharides are described in U.S. application Ser. No. 10/854,595.

One structure of a highly branched polysaccharide is shown below.

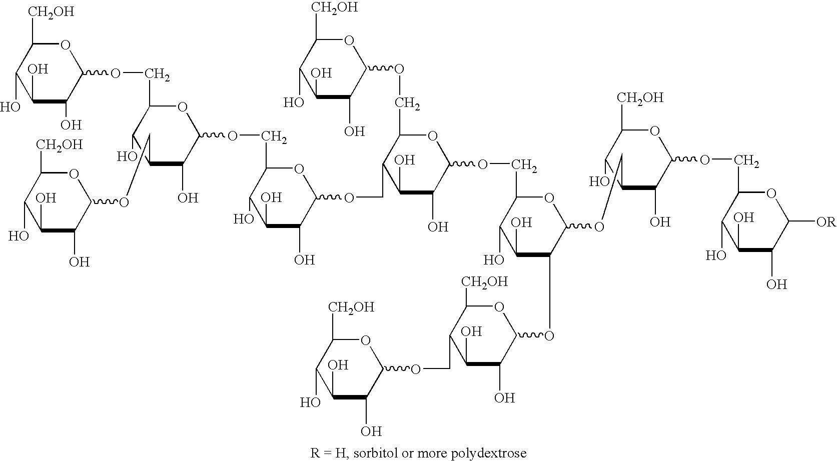

Normally highly branched polysaccharides have a relatively poor solubility in polyether polyols having a hydroxyl value of said highly branched polysaccharides at high active hydrogen functionality and molecular weight. Accordingly, it would be highly desirable to have convenient means for incorporation of highly branched polysaccharides in a polyurethane foam matrix. More particularly, it would be very advantageous to be able to incorporate into the polyurethane foam matrix a highly branched polysaccharide having a high active hydrogen functionality and which may be readily processed in a polyurethane foam production facility.

It is an object of the present invention to provide novel highly branched polysaccharides which obviate or mitigate at least one of the above-mentioned disadvantages of the prior art.

It should be noted that all documents cited in this text (“herein cited documents”) as well as each document or reference cited in each of the herein-cited documents, and all manufacturer's literature, specifications, instructions, product data sheets, material data sheets, and the like, as to the product mentioned in this text, are hereby expressly incorporated herein by reference.

### SUMMARY OF THE INVENTION

The present invention relates to a highly branched polysaccharide derivatized to provide a hydrophobicity which renders it compatible with a polyether polyol with which the underivatized polysaccharides are incompatible. The polysaccharide comprises of randomly bonded glucopyranose units, having an average number of 10-100 glucose residues and the derivatized polysaccharide has an active hydrogen functionality of 15 or more. The glycosidic bonds of the polysaccharide may be alpha or beta and may consist of any of the possible combinations, 1,2 to 1,6; 2,1 to 2, 6; etc.

The invention also relates to a mix for the production of a polyurethane. The mix comprises a polyether polyol, a highly branched polysaccharide of randomly bonded glucopyranose units, having an average number of 10-100 glucose residues, wherein said polysaccharide has an active hydrogen functionality of at least 15 and is derivatized to provide a hydrophobicity which renders it compatible with said polyether polyol with which the underivatized polysaccharide is incompatible. The mix may further comprise a blowing agent, at least one catalyst and at least one surfactant.

A polyurethane may be formed by the reaction between the mix containing isocyanate-reactive hydrogens, and an isocyanate chosen from the class of readily available isocyanato aromatic compounds.

### DETAILED DESCRIPTION OF THE INVENTION

The present inventors have surprisingly found that highly branched polysaccharides are suitably modified to increase their hydrophobic character, and thereby their compatibility with polyether polyols. These derivatized highly branched polysaccharides in polyurethane formulations provide advantageous load building characteristics in high density and in foamed isocyanate-based polymers. They may be used to partially or to fully displace the conventional copolymer polyols used.

Accordingly, the present invention discloses a novel group of derivatized highly branched polysaccharides which may be conveniently incorporated in polyurethane foams. The novel group of derivatized highly branched polysaccharides confer significant load building properties to a polyurethane foam matrix and may be used for this purpose to partially or fully displace current relatively expensive chemical systems which are used to confer load building characteristics to polyurethane foams.

A feature of the present derivatized highly branched polysaccharide is that at least 5% by weight of the derivatized highly branched polysaccharide may be mixed with a polyether polyol having a hydroxyl value of 60 or less to form a stable, i.e. uniform liquid at 23° C.

Unless otherwise specified, the terms used in the present specification and claims shall have the following meanings.

The term “highly branched” when used to describe the polysaccharide of the invention refers to a polysaccharide which has at least some doubly or triply branched units. A glucopyranose unit which has three linkages is a doubly branched unit and a unit which has four linkages is a triply branched unit. The area (%) of double and/or triple branches in a linkage analysis of the polysaccharide is preferably 0.5-10%, more preferably 1-7% and most preferably 2-5%. Specific examples of such highly branched polysaccharides comprise polydextrose and a polysaccharide produced from starch in a heat treatment process known as pyroconversion. The highly branched polysaccharide of the invention may further be alkoxylated.

The term “functionality” of the derivatized highly branched polysaccharide and its derivative is dependent upon the average number of glucose residues and refers to the number active hydroxyl groups per molecule. For the purposes of “functionality,” the polysaccharide molecule is defined as low-monomer polysaccharide. Normally in a strict sense functionality refers to the number of isocyanate-reactive hydrogens on molecules in the polyol side of the formulation.

The term “polydextrose” as used herein refers to one example of a highly branched polysaccharide. It includes polymer products of glucose which are prepared from glucose, maltose, oligomers of glucose or hydrolyzates of starch, which are polymerized by heat treatment in a polycondensation reaction in the presence of an acid e.g. Lewis acid, inorganic or organic acid, including monocarboxylic acid, dicarboxylic acid and polycarboxylic acid, such as, but not limited to the products prepared by the processes described in the following U.S. Pat. Nos. 2,436,967, 2,719,179, 4,965,354, 3,766,165, 5,051,500, 5,424,418, 5,378,491, 5,645,647 5,773,604, or 6,475,552, the contents of all of which are incorporated herein by reference.

The term polydextrose also includes those polymer products of glucose prepared by the polycondensation of glucose, maltose, oligomers of glucose or starch hydrolyzates described hereinabove in the presence of a sugar alcohol, e.g. polyol, such as in the reactions described in U.S. Pat. No. 3,766,165. Moreover, the term polydextrose includes the glucose polymers, which have been purified by techniques described in prior art, including any and all of the following but not limited to (a) neutralization of any acid associated therewith by base addition thereto, or by passing a concentrated aqueous solution of the polydextrose through an adsorbent resin, a weakly basic ion exchange resin, a type II strongly basic ion-exchange resin, mixed bed resin comprising a basic ion exchange resin, or a cation exchange resin, as described in U.S. Pat. Nos. 5,667,593 and 5,645,647, the contents of which are incorporated by reference; or (b) decolorizing by contacting the polydextrose with activated carbon or charcoal, by slurrying or by passing the solution through a bed of solid adsorbent or by bleaching with sodium chlorite, hydrogen peroxide and the like; (c) molecular sieving methods, like UF, RO (reverse osmosis), size exclusion, and the like; (d) or enzymatically treated polydextrose or (e) any other recognized techniques known in the art. Among the purification processes used in the art the following may be especially mentioned: bleaching, e.g. using hydrogen peroxide as described in U.S. Pat. No. 4,622,233; membrane technology as described in U.S. Pat. No. 4,956,458; ion exchange e.g. removal of citric acid as described in U.S. Pat. No. 5,645,647 or removal of color/bitter taste as described in U.S. Pat. No. 5,091,015; chromatographic separation, with a strong cation exchanger as described in WO92/12179; hydrogenation, in combination with ion exchange as described in U.S. Pat. No. 5,601,863; U.S. Pat. No. 5,573,794 or with ion exchange and chromatographic separation as described in U.S. Pat. No. 5,424,418; or solvent extraction as described in U.S. Pat. No. 4,948,596; EP 289 461, the contents of said patents being incorporated by reference.

Moreover, the term polydextrose includes hydrogenated polydextrose, which, as used herein, includes hydrogenated or reduced polyglucose products prepared by techniques known to one of ordinary skill in the art. Some of the techniques are described in U.S. Pat. Nos. 5,601,863, 5,620,871 and 5,424,418, the contents of which are incorporated by reference. The term polydextrose also encompasses fractionated polydextrose which is a conventional, known material and can be produced e.g. by the processes disclosed in U.S. Pat. Nos. 5,424,418 and 4,948,596 the contents of which are incorporated by reference.

Polydextrose is commercially available from companies such as Danisco Sweeteners, Staley and Shin Dong Bang. Purified forms of polydextrose are marketed by Danisco Sweeteners under the name Litesse® or Litesse® II and by Staley under the name Stalite® III. A reduced form of Litesse® is called Litesse® Ultra. The specifications of the Litesse® polydextrose products are available from Danisco Sweeteners.

A further highly branched polysaccharide is derived by pyroconversion from starch. Starch is made of glucose molecules attached by α-(1,4) bonds, with some branching by means of α-(1,6) bonds. The degree of branching depends on the source of the starch. The polysaccharide is produced from starch in a heat treatment process known as pyroconversion. Pyrodextrins are starch hydrolysis products obtained in a dry roasting process either using starch alone or with trace levels of acid catalyst. The first product formed in this reaction is soluble starch, which in turn hydrolyzes further to form dextrins. The molecular weight of the final product depends on the temperature and duration of heating. Transglucosidation can occur in the dextrinization process, in which rupture of an α-(1,4) glucosidic bond is immediately followed by combination of the resultant fragments with neighboring hydroxyl groups to produce new linkages and branched structures. Thus, a portion of the glycosidic bonds are scrambled. A commercially available pyroconverted starch is called Fibersol-2® and is available from Matsutani America, Inc.

As used throughout this specification, the term “compatible”, when used in connection with the solubility characteristics of the derivatized highly branched polysaccharide, it is intended to mean that the liquid formed upon mixing the derivatized highly branched polysaccharide and the polyether polyol does not cause precipitation and thus is uniform and stable. Further the formed liquid has a substantially constant light transmittance (transparent at one extreme and opaque at the other extreme) for at least 2 hours, preferably at least 30 days, more preferably a number of months, after production of the mixture. In different embodiments, the stable liquid will be in the form of a clear, homogeneous liquid (e.g., a solution) which will remain as such over time or in the form of an emulsion of the derivatized highly branched polysaccharide in the polyol which will remain as such over time—i.e. the polysaccharide will not settle out over time. The polarity may moreover be reflected by a term known as the solubility parameter (δ), a value which for the very polar water is 23.4 and decreases as one moves to very non polar solvents as methyl t-butyl ether, for which the solubility parameter is 7.4. A polymer with a solubility parameter similar to the solvent will dissolve in it. Components with dramatic differences in solubility parameters, for example water and oil—will not dissolve.

The term “compatibility indicating mixture” refers to a mixture of the derivatized highly branched polysaccharide and a polyether polyol, which forms a uniform liquid at 23° C. The hydrophobicity of the derivatized highly branched polysaccharide is sufficient to provide a uniform liquid mixture although the underivatized polysaccharide is incompatible with the polyether polyol, i.e. does not form a uniform liquid mixture in the same conditions.

The term “load efficiency”, as used throughout this specification, indicates the ability of the derivatized highly branched polysaccharide to generate firmness in an isocyanate based foam matrix. The efficiency is defined as the number of Newtons of foam hardness increase per % of the derivatized highly branched polysaccharide in the resin blend. Typically, foam firmness is described using Indentation Force Deflection (IPD) at 50% deflection or Compressive Load Deflection (CLD) at 50% deflection, measured pursuant to ASTM D3574. An IFD number represents the pounds of force required to indent a foam sample by a specified percentage of its original thickness. The CLD values are given in pounds per square inch (psi). The force in pounds needed to compress the sample is recorded and the result is reported in psi by dividing the force by the surface area of the sample.

The term “index” refers to the ratio of isocyanate groups of the isocyanate and hydroxyl groups of the polyol composition [NCO/OH].

The term “polyurethane” is used both when urethanes and isocyanurates are included. For the purposes of this invention no special distinction is made between polyurethanes and polyisocyanurates.

In the specification and the claims the term “adding an organic isocyanate to a polyol composition” includes combining the two components irrespectively of which is added to which in connection with the process of the present invention.

The derivatized highly branched polysaccharide of the invention comprises randomly bonded glucopyranose units and has an average number of 10-100 glucose residues. Moreover the polysaccharide has an active hydrogen functionality of at least 15, preferably 15 to 70, more preferably 20 to 60, most preferably 30 to 50. The polysaccharide is derivatized to provide a hydrophobicity which renders it compatible with a polyether polyol with which the underivatized polysaccharide is incompatible.

There are a number of ways to increase the hydrophobic character of these highly branched polysaccharides. For example, an octenylsuccinylation may be carried out as described in U.S. Pat. Nos. 4,035,235; 5,672,699; or 6,037,466. However, a preferred approach is esterification with a fatty acid, preferably containing 6 to 12 carbon atoms. Methods for esterifying similar structures such as starch are described in U.S. Pat. Nos. 2,461,139; 4,720,544; 5,360,845; 6,455,512; and 6,495,679. Methods for esterifying other polysaccharides are disclosed in U.S. Pat. Nos. 4,517,360; 4,518,772; 5,589,577; 5,840,883; 5,977,348; and 6,706,877.

There are several different synthetic routes described in prior art. Modifying starch with solvents are described in U.S. Pat. Nos. 5,589,577, 5,681,948, 5,840,883 and 6,495, 679. Methods for producing alkyl ester derivatives of sucrose, which reactions require no solvent and are carried out under vacuum in the melt are described in U.S. Pat. Nos. 4,517,360, 4,518,772, 5,585,506, 5,681,948, 5,767,257, 5,945,519, 6,080,853, 6,121,440, 6,303,777, 6,620.952 and 6,706,877. Another derivatization procedure described in 4,011,389, 4,223,129, 4,720,544, 4,950,743, 5,886,161, 6,100,391 and 6,204,369 covers the reaction of a long chain alcohol directly with the polysaccharide producing glucoside structure. A process where the same number of hydroxyl groups remains in the final product and where a long chain a olefin epoxide monomer in the presence of base is added to polyols to introduce the desired hydrophobicity is described in U.S. Pat. Nos. 3,932,532 and 4,011,389. Processes where water is present are described in U.S. Pat. Nos. 2,461,139, 3,318,868, 4,720,544, 5,360,845, 6,011,092, 6,455,512 and 6,605,715. A process for modifying carbohydrates which utilizes epichlorohydrin which is reacted with a long chain alcohol in the presence of a Lewis acid catalyst and after neutralization, and were the product is added to a polyglycerol which has been converted to its alkoxide is described in U.S. Pat. No. 4,086,279. Moreover a process for esterification of starch where high boiling solvents such as DMF or DMSO are replaced by supercritical CO₂ is described in U.S. Pat. No. 5,977,348.

A particularly straight forward method is comprised of the steps of: mixing a highly branched polysaccharide with a suitable ether or aromatic hydrocarbon solvent, such as tetrahydrofuran, diethylene glycol dimethyl ether, xylene or toluene; adding a base, such as NaOH or KOH; and, then the carboxylic acid. The reaction is driven to completion with heat and at the same time removing water.

Alternatively, the hydrophobe imparting carboxylic acid moiety can be added during or near the completion of the polysaccharide preparation reaction.

As described above the preferred polysaccharide composition utilized in the process for preparing a polyurethane comprises a derivatized highly branched polysaccharide of randomly bonded glucopyranose units having an average number of 10-100 glucose residues. The preferred weight of fatty acid residues is 5 to 50%, preferably 15 to 40% based on the weight of the final a derivatized highly branched polysaccharide.

The hydrophobicity of the derivatized highly branched polysaccharide is sufficient to cause a mixture of said polysaccharide and said polyether polyol with which the underivatized polysaccharide is incompatible. This compatibility indicating mixture comprises at least 5% (w/w) of said polysaccharide and still forms a uniform liquid at 23° C. Preferably the compatibility indicating mixture comprises 5 to 50%, more preferably 5 to 40%, most preferably 5 to 30% of the polysaccharide and still forms a uniform liquid at 23° C.

In one embodiment of the invention the polysaccharide is derivatized by a chemical reaction with a hydrophobic organic compound comprising-6-20 carbon atoms selected from aliphatic and aromatic carbon atoms and combinations thereof. More in detail; the organic compound is selected from C₆-C₁₂ carboxylic acids and C₆-C₁₂ organic alcohols. In a preferred embodiment the carboxylic acid is selected from fatty acids or reactive derivatives thereof. The organic alcohols can be selected from diols and monols, preferably containing at least one primary hydroxyl group.

In a preferred embodiment ester groups are introduced to the polysaccharide whereupon the solubility parameter of the polysaccharide derivatives lowers. When the solubility parameter is below 14, preferably below 12 the modified polysaccharide dissolves in solvents in which underivatized and less substituted polysaccharide is insoluble. The hydrophilicity decreases and therefore the solubility of the polysaccharide derivatives in less polar solvents increases as the degree of substitution increases.

In a preferred embodiment where the polysaccharide is derivatized with a fatty acid the weight of fatty acid residues in the derivatized polysaccharide is 5 to 50%, more preferably 15 to 40% based on the weight of the derivatized highly branched polysaccharide.

The polyether polyol, with which the underivatized polysaccharide is incompatible may primarily comprise polypropylene oxide, preferably at least 50% polypropylene oxide, more preferably at least 70%, still more preferably 70 to 90%, most preferably 75 to 80%. It may preferably have a hydroxyl value of at most 60 mg KOH/g, more preferably 15 to 55 mg KOH/g, most preferably 28 to 36 mg KOH/g.

Further the polyether polyol may have a molecular weight in the range of from 200 to 12,000, preferably from 2,000 to 7,000, most preferably from 2,000 to 6,000.

In one embodiment of the present invention the polysaccharide consists of randomly cross-linked glucose units with all types of glycosidic bonds, containing minor amounts of a bound sugar alcohol and an acid, and having an average molecular weight between about 1,500 and 18,000. The polysaccharide has predominantly 1,6 glycosidic bonds and is a polycondensation product of glucose, maltose or other simple sugars or glucose-containing material such as hydrolyzed starch and a sugar alcohol in the presence of an acid, preferably a carboxylic acid.

Examples of suitable acids include, but are not limited to mono, di or tri carboxylic acid or their potential anhydrides, such as formic, acetic, benzoic, malonic, fumaric, succinic, adipic, itaconic, citric and the like, and/or a mineral acids, such hydrochloric acid, sulfuric acid, sulfurous acid, thiosulfuric acid, dithionic acid, pyrosulfuric acid, selenic acid, selenious acid, phosphorous acid, hypophosphorous acid, pyrophosphoric acid, polyphosphoric acid, hypophosphoric acid, boric acid, perchloric acid, hypochlorous acid, hydrobromic acid, hydriodic acid and silicic acid; acidic alkali metal or alkaline earth metal salts of the above acids such as sodium bisulfate and sodium bisulfite; or mixtures of these acids (and/or acidic alkali or alkaline earth metals salts) with phosphoric acid and the like at about 0.001-3%. The polysaccharide thus produced will contain minor amounts of unreacted sugar alcohol and/or acid and a mixture of anhydroglucoses (reaction intermediates).

In a preferred embodiment the sugar alcohols are selected from the group consisting of sorbitol, glycerol, erythritol, xylitol, mannitol, galactitol or mixtures thereof, typically at a level of 5-20% by weight, preferably 5-15%, more preferably 8-12%.

The polysaccharide formed may be further purified or modified by a variety of chemical and physical methods used alone or in combination. These include, but are not limited to: chemical fractionation, extraction with organic solvents, neutralization with a suitable base, purification by chromatography (such as ion exchange or size exclusion), membrane or molecular filtration, further enzyme treatment, carbon treatment and hydrogenation, which is a specific process of reduction.

In the most preferred embodiment of the invention the polysaccharide is a polycondensation product of glucose, sorbitol and citric acid. The water soluble polysaccharide is produced by reacting glucose with sorbitol (8-12% by weight) in the presence of citric acid (0.01-1% by weight) under anhydrous melt conditions and reduced pressure. The polysaccharide may be purified by ion exchange to produce a form in which the acidity is less than 0.004 meq/gm; referred to as low-acidity polyol. Or, it may be purified by a combination of ion exchange and hydrogenation; referred to as hydrogenated polyol. Upon hydrogenation the reducing saccharides are typically less than 0.3% of the total carbohydrate content. Or, it may be further purified by anion exchange and molecular filtration to reduce acidity and the concentration of monomeric reaction by-products; referred to as low-monomer polyol. A portion of the water used in processing may be removed to achieve the desired moisture content. In the low-acidity and hydrogenated forms the polysaccharide constitutes about 90% of the total carbohydrate content: the remainder consisting of glucose, sorbitol and anhydroglucoses. In the low-monomer form the polysaccharide constitutes 99+% of the total carbohydrate content. In this most preferred embodiment the highly branched polysaccharide is a polydextrose.

The water content in all the above mentioned cases may also be adjusted to allow milling as either a coarse or fine powder. The amount of water may however also define the need of isocyanate. If more water is present, the needed amount of isocyanate increases. On the other hand the use of a higher amount of isocyanate may lead to a polyurethane foam which is hard and may have a stiff feeling i.e. is “boardy”.

In another embodiment of the invention the polysaccharide has predominantly beta-1,4 linkages and a varying number of glucose residues which are hydrolyzed from starch to form dextrins and subsequently linked to form branched structures. In this embodiment the polysaccharide is preferably pyroconverted starch.

In a preferred embodiment of the invention the derivatized highly branched polysaccharide is a polydextrose having an active hydrogen functionality of at least 15, which is derivatized with a C₈₋₁₂-fatty acid to provide a hydrophobicity which renders it compatible with a polyether polyol with which the underivatized polydextrose is incompatible.

Furthermore the invention relates to a mix for the production of a polyurethane comprising a mixture of a polyether polyol and a highly branched polysaccharide of randomly bonded glucopyranose units, having an average number of 10-100 glucose residues. The polysaccharide has an active hydrogen functionality of at least 15 and is derivatized to provide a hydrophobicity which renders it compatible with said polyether polyol with which the underivatized polysaccharide is incompatible.

In a preferred embodiment the mix comprises 1 to 50%, more preferably 5 to 20%, most preferably 10 to 15% by weight of the polysaccharide.

A suitable mix may comprise one or more polyether polyols, copolymer polyols, blowing agent(s), catalyst(s), surfactant(s) and additives, for example pigments or fillers or ingredients necessary to achieve a desired property such as flame retardancy, increased durability etc. The following constituents noted in parts per hundred polyol may be added to the mix: water (1-30), catalyst (1-10), surfactant (1-25), crosslinking agent (0-30) and if desired, an auxiliary blowing agent (0-100).

In a preferred embodiment the derivatized highly branched polysaccharide of the present invention is used as a partial or total replacement for copolymer polyols in high resilient (HR) molded flexible polyurethane foam applications. High resilient foams are for example used as cushion material in household furnishings and automobiles. The derivatized highly branched polysaccharide or mix of the invention may also be used as a partial or total replacement for copolymer polyols in carpet underlay and packaging foam applications.

In another preferred embodiment the mix of the invention may in addition to the polyether polyol and the polysaccharide comprise at least one catalyst and at least one surfactant. The mix of the invention may further comprise at least one blowing agent selected from water, non-water blowing agents, liquid carbon dioxide and combinations thereof and the blowing agent may also comprise water. Preferably the non-water blowing agents are low-boiling organic liquids, such as acetone, methyl, formate, formic acid, pentane(s), isopentane, n-pentane or cyclopentane, HCFC 141, HFC 245, HFC 365, HFC 134, HFC 227 or a mixture thereof.

Moreover, crosslinking agents, additives like pigments or fillers and other additional components may be added. Although, the derivatized highly branched polysaccharide mainly reacts with the isocyanate, in some embodiments of the invention it can also serve as filler.

Any suitable catalyst and surfactant known in the art may be used to obtain the desired characteristics. In a preferred embodiment the catalyst may be selected from the group consisting of tertiary amines and metallic salts or mixtures thereof. Amine catalysts can include, but are not limited to methyl morpholine, triethylamine, trimethylamine, triethylenediamine and pentamethyldiethylenetriamine. Metallic salts can include, but are not limited to tin or potassium salts such as potassium octoate and potassium acetate. A mixture of catalysts is preferred (e.g. Polycat®5, 8,46K; Dabco® K15, 33LV, TMR—all produced by Air Products; Jeffcat® ZF10—produced by Huntsman). In a preferred embodiment the surfactants may be silicone surfactants used to aid dimensional stability and uniform cell formation. Examples of suitable silicone surfactants are the Dabco® series DC5890, DC 5598, DC5043, DC5357 and DC193—all produced by Air Products.

The mixture may further comprise a crosslinking agent selected from the group consisting of triethanolamine, glycerin and trimethylol propane. In a preferred embodiment of the invention 1-2% diethanolamine by weight of the mix is added to the mixture. Moreover, additives like pigments or fillers and other additional components may be added.

In a preferred embodiment of the invention the mix comprises a polyether polyol and a polysaccharide which is a polydextrose having an active hydrogen functionality of at least 15, derivatized with a C₈₋₁₂-fatty acid to provide a hydrophobicity which renders it compatible with a polyether polyol with which the underivatized polydextrose is incompatible.

The isocyanates in the present invention may come from the class of readily available isocyanato aromatic compounds. Depending upon the desired properties, examples of preferred aromatic isocyanates include 2,4 and 2,6 toluene di-isocyanate (TDI) such as that prepared by the phosgenation of toluene diamine produced by the nitration and subsequent hydrogenation of toluene. The TDI may be a mixture of the 2,4 and 2,6 isomers in ratios of either 80:20 or 65:35 with the more preferred being 80:20 (e.g. TDI 80 produced by Lyondell). Another preferred isocyanate is methylene diphenylisocyanate (MDI) such as prepared by the condensation of aniline and formaldehyde with subsequent phosgenation. The MDI may be a mixture of 2,4′ and 4,4′methylene diphenyldiisocyanate as well as a mixture of the 2,4 and 4,4 isomers with compounds having more than two aromatic rings—polymeric-MDI or PMDI (e.g. Lupranate® M20S—produced by BASF, PAPI®27—produced by Dow and Mondur®MR produced by Bayer).

A polyurethane foam may be prepared from the polysaccharide or mix of the invention by mixing a polyether polyol and polysaccharide with at least one surfactant, at least one catalyst and at least one blowing agent selected from water and non-water agents, adding an organic isocyanate and allowing the mixture to foam. Special additives, such as fillers, flame retarding agents, crosslinking agents and agents for increased durability may be included. Such additives are preferably added in amounts which are common in the art and thus well known to those skilled in the art. However, a special filler of the present invention comprises the branched polysaccharide which is included in the mix of the invention. The ratio of isocyanate groups of said isocyanate and hydroxyl groups of said polyol is from 1.2:1 to 1:1.2, preferably 1.1:1 to 1:1.1. The use of the novel derivatized highly branched polysaccharides to partially or fully displace copolymer polyols conventionally used to confer load building characteristics in isocyanate-based polymer foams, are described in detail in U.S. patent application No. U.S. 60/618,958 filed on the same day, in the name of the same inventors and with the title “A foamed isocyanate-based polymer, a mix and process for production thereof”, the contents of which are hereby incorporated by reference.

The following examples are given to further illustrate the invention and are not intended to limit the scope thereof. Based on the above description a person skilled in the art will be able to modify the invention in many ways to provide derivatized polysaccharides and polyurethanes with a wide range of defined properties.

Example 1 discloses preparation of a highly branched polysaccharide and example 2 solubility of the polysaccharide according to Example 1. Examples 3 to 6 illustrate production and derivatization of highly branched polysaccharides, Example 7 discloses solubility evaluations of the derivatized highly branched polysaccharides of Examples 3 to 6, and Examples 8 to 10 illustrate the use of the derivatized highly branched polysaccharide of Example 3 in isocyanate based foam. Examples 11 and 12 discloses comparative isocyanate based foams without derivatized highly branched polysaccharides.

Examples 13 to 15 illustrate three different reactions of polydextrose esters and example 16 discloses production of polydextrose ether. Example 17 discloses solubility evaluations of some of the polydextrose esters of examples 14 and 15. Examples 18-21 discloses comparative isocyanate based foams without polydextrose and examples 22-27 discloses the use of some of the polydextrose esters of example 14 and 15 in isocyanate based foams.

### EXAMPLE 1 (COMPARATIVE)

A mixture of 267 grams of dextrose monohydrate (244 gram anhydrous dextrose) and 30 grams of sorbitol is melted and heated under partial vacuum, with stirring, to 130 C., a solution of 0.3 gram of citric acid in 5 milliliters of water is added, the temperature of the mixture is increased to 152° C., and stirring is continued for 22 minutes under partial vacuum at 152-188° C. After removing water under vacuum, 252 grams of product is obtained. The product has a final hydroxyl number of 830. (equivalent wt=68)

The solubility of the highly branched polysaccharides according to Example 1 in a glycerol based polyether polyol with a hydroxyl value of 32 mg KOH/g is evaluated.

### EXAMPLE 2

15.0 g of respective highly branched polysaccharide according to Example 1 is added to a beaker containing 75.0 g of a glycerol based polyether polyol with a hydroxyl value of 32 mg KOH/g. The mixture is heated under stirring to 120° C. during 30 minutes and then allowed to cool down to room temperature. The ability for the highly branched polysaccharide to form a stable solution with the polyether polyol is evaluated after 120 minutes.

If the highly branched polysaccharides of Examples 1 is unable to form a stable solution with the glycerol based polyether polyol of hydroxyl value 32 mg KOH/g. the highly branched polysaccharide according to Examples 1 partly precipitate from the solution and this can be observed in the form of a separate phase at the bottom of the beaker.

### EXAMPLE 3

25 kg of the highly branched polysaccharide according to Example 1, 8.4 kg of an aliphatic acid with nine carbon atoms having an acid number of 363 mg KOH/g, 0.1 kg KOH and 3.3 kg of xylene are charged to a reactor equipped with a heating system with accurate temperature control, a mechanical stirrer a pressure gauge, a vacuum pump, a Dean-Stark device for azeotropic removal of water, a cooler, nitrogen inlet and a receiver. The mixture is heated under stirring, with a nitrogen flow of 500-600 l/h through the reaction mixture, from room temperature to 170° C. At this temperature all xylene is refluxing and the reaction water which started to form is removed by azeotropic distillation. The reaction is allowed to continue for a further 12 hours at 170° C., after which the reaction temperature is increased to 180° C. The reaction mixture is kept at this temperature for a further 2.5 hours until an acid value of 6 mg KOH/g is obtained. Full vacuum is then applied to the reactor to remove all xylene from the final product. Approximately 32.4 kg of the derivatized, highly branched polysaccharide is obtained and this product has a hydroxyl value of 545 (equivalent wt=103).

### EXAMPLE 4

25 kg of the highly branched polysaccharide according to Example 1, 12 kg of an aliphatic acid with nine carbon atoms having an acid number of 363 mg KOH/g, 0.1 kg KOH and 3.3 kg of xylene are charged to a reactor equipped with a heating system with accurate temperature control, a mechanical stirrer a pressure gauge, a vacuum pump, a Dean-Stark device for azeotropic removal of water, a cooler, nitrogen inlet and a receiver. The mixture is heated under stirring, with a nitrogen flow of 500-600 l/h through the reaction mixture, from room temperature to 170° C. At this temperature all xylene is refluxing and the reaction water which started to form is removed by azeotropic distillation. The reaction is allowed to continue for a further 12 hours at 170° C., after which the reaction temperature is increased to 180° C. The reaction mixture is kept at this temperature for a further 2.5 hours until an acid value of 6 mg KOH/g is obtained. Full vacuum is then applied to the reactor to remove all xylene from the final product. Approximately 35.6 kg of the derivatized, highly branched polysaccharide is obtained and this product has a hydroxyl value of 460 (equivalent wt=122).

### EXAMPLE 5

A mixture of 267 grams of dextrose monohydrate (244 gram anhydrose dextrose) and 30 grams of sorbitol is melted and heated under partial vacuum, with stirring, to 130 C., a solution of 0.3 gram of citric acid in 5 milliliters of water is added, the temperature of the mixture is increased to 152 C., and stirring is continued for 22 minutes under partial vacuum at 152-188 C. Then, 100 g of an aliphatic acid with nine carbon atoms having an acid number of 363 mg KOH/g, is added and the stirring under partial vacuum at 152-188 C is continued for another 30 minutes to remove the water. Approximately 341 grams of the derivatized, highly branched polysaccharide is obtained and this product has a hydroxyl value of 505 (equivalent wt=111).

### EXAMPLE 6

A mixture of 267 grams of dextrose monohydrate and 30 grams of sorbitol is melted and heated under partial vacuum, with stirring, to 130 C., a solution of 0.3 gram of citric acid in 5 milliliters of water is added, the temperature of the mixture is increased to 152 C., and stirring is continued for 22 minutes under partial vacuum at 152-188 C. Then, 150 g of an aliphatic acid with nine carbon atoms having an acid number of 363 mg KOH/g, is added and the stirring under partial vacuum at 152-188 C is continued for another 30 minutes. Approximately 385 grams of the derivatized, highly branched polysaccharide is obtained and this product has a hydroxyl value of 401 (equivalent wt=140).

### EXAMPLE 7

The solubility of each of the derivatized highly branched polysaccharides according to Examples 3-6 in a glycerol based polyether polyol with a hydroxyl value of 32 mg KOH/g is evaluated.

15.0 g of respective derivatized highly branched polysaccharide according to Examples 3-6 is added to a beaker containing 75.0 g of a glycerol based polyether polyol with a hydroxyl value of 32 mg KOH/g. The mixture is heated under stirring to 120° C. during 30 minutes and then allowed to cool down to room temperature. The ability for each derivatized highly branched polysaccharide to form a stable solution with the polyether polyol is evaluated after 120 minutes.

The solubility of the evaluated derivatized highly branched polysaccharides according to Example 3-6 in the glycerol based polyether polyol is confirmed. If fully transparent solutions, which are stable over time are obtained it shows excellent solubility. Samples of higher concentrations based on the products obtained according to Examples 3-6 are then prepared. These are then evaluated with regard to viscosity at 23° C. Samples of different concentrations of derivatized highly branched polysaccharide according to Examples 3-6 in polyether polyol are prepared and found to be fully compatible with the base glycerol based polyether polyol if these stable solutions remains as such even after 30 days.

### EXAMPLES 8-12

Examples 8-12 illustrate the use of the present derivatized highly branched polysaccharide in a typical isocyanate based high resilient (HR) based foam. In each Example, the isocyanate based foam is prepared by the pre-blending of all resin ingredients including polyols, copolymer polyols (if used), catalysts, water, and surfactants as well as the derivatized highly branched polysaccharide of interest (if used). The isocyanate is excluded from the mixture. The resin blend and isocyanate are then mixed at an isocyanate index of 100 using a conventional two-stream mixing technique and dispensed into a preheated mold (65° C.) having the dimensions 38.1×38.1×10.16 cm. The mold is then closed and the reaction allowed to proceed until the total volume of the mold is filled. After approximately 6 minutes, the isocyanate based foam can be removed and, after proper conditioning, the properties of interest are measured. The methodology will be referred to in Examples 8-12 as the General Procedure.

In Examples 8-12, the following materials are used:

E837, base polyol, commercially available from Lyondell;

E850, a 43% solids content copolymer (SAN) polyol, commercially available from Lyondell;

D-PDX, a derivatized highly branched polysaccharide produced Example 3 above;

DEAO LF, diethanol amine, a crosslinking agent commercially available from Air Products;

Glycerine, a crosslinking agent, commercially available from Van Waters & Rogers;

Water, indirect blowing agent;

Dabco 33LV, a gelation catalyst, commercially available from Air Products;

Niax A-1, a blowing catalyst, commercially available from Witco;

Y-10184, a surfactant, commercially available from Witco;

Lupranate T80, isocyanate (toluene diisocyanate—TDI), commercially available from BASF.

Unless otherwise stated, all parts reported in Examples 8-12 are in parts by weight.

In Examples 8-12, isocyanate based foams based on the formulations shown in Table 1 are produced using the General procedure referred to above.

In Examples 8-10, isocyanate based foams are prepared in the absence of any copolymer polyol. The isocyanate based foams are formulated with a H₂O concentration of 3.8% resulting in an approximate foam core density of 1,9 pcf. The level of derivatized highly branched polysaccharide is varied from 6.7% to 13.4% by weight in the resin.

The results of physical property testing for each foam is the density and Indentation Force Deflection (IPD) at 50% deflection, measured pursuant to ASTM D3574. The introduction of the derivatized highly branched polysaccharide to the isocyanate based polymer matrix results in a greatly improved hardness increase for the foam from Example 8 to Example 9, and for the foam from Example 9 to Example 10. The hardness is improved with the increase of the amount of derivatized highly branched polysaccharide.

By this analysis, a “load efficiency” for each foam may be reported and represents the ability of the derivatized highly branched polysaccharide to generate firmness in the isocyanate based foam matrix. The efficiency is defined as the number of Newtons of foam hardness increase per % of the derivatized highly branched polysaccharide in the resin blend.

The introduction of the derivatized highly branched polysaccharide results in a foam hardness increase.

In Examples 11 and 12, isocyanate based foams based on the formulations shown in Table 1 are produced using the General Procedure referred to above.

In Examples 11 and 12, isocyanate based foams are prepared in the absence of any derivatized highly branched polysaccharide. Copolymer polyol is used to increase foam hardness. Thus, it will be appreciated that Examples 11 and 12 are provided for comparative purposes only and are outside the scope of the present invention. The isocyanate based foams are formulated with a H₂O concentration of 3.8% resulting in an approximate foam core density of 1,9 pcf. The level of the copolymer polyol is varied from 8 to 26% by weight in the resin.

The result of physical property testing for the introduction of the copolymer results in a foam hardness which however is not as good as for the foams of Examples 8 to 10.

TABLE 1

| | Examples | | | | |
|---|---|---|---|---|---|
| Ingredient | 8 | 9 | 10 | 11 | 12 |
| E837 | 86.6 | 83.2 | 79.9 | 32.6 | 74.7 |
| E850 | — | — | — | 60.9 | 18.7 |
| D-PDX | 6.7 | 10.1 | 13.4 | — | — |
| DEOA LF | 1.0 | 1.0 | 1.0 | 1.0 | 1.0 |
| glycerin | 0.6 | 0.6 | 0.6 | 0.6 | 0.6 |
| water | 3.7 | 3.7 | 3.7 | 3.7 | 3.7 |
| Dabco 33LV | 0.4 | 0.4 | 0.5 | 0.3 | 0.3 |
| Niax A-1 | 0.07 | 0.07 | 0.07 | 0.07 | 0.07 |
| DC5169 | — | — | — | — | — |
| Y10184 | 0.9 | 0.9 | 0.9 | 0.9 | 0.9 |
| Total Resin | 100.0 | 100.0 | 100.0 | 100.0 | 100.0 |
| Lupranate T80 | 50.9 | 53.6 | 56.3 | 38.1 | 38.7 |
| Index | 100 | 100 | 100 | 100 | 100 |
| % water | 3.8 | 3.8 | 3.8 | 3.8 | 3.8 |
| % SAN in resin | 0 | 0 | 0 | 26 | 8 |
| % HBP in resin | 6.7 | 10.0 | 13.4 | 0 | 0 |
| Total dry weight (g) | 444 | 440 | 441 | 514 | 519 |
| Density (pcf) | 1.9 | 1.9 | 1.9 | 1.9 | 1.9 |

| | | |
|---|---|---|
| 50% IFD (N) | INCREASES -> | DECREASES -> |

| | | |
|---|---|---|
| % Hysteresis | ACCEPTABLE | LOW |

| | | |
|---|---|---|
| Load Efficiency | EXCELLENT | ACCEPTABLE |

### EXAMPLE 13

Polydextrose Ester—Reaction of Polydextrose with a Mixture of Methyl Esters

(Theoretical Level of OH Replacement ˜30%)

A mixture of 9.8 g (0.15 mole) of 85% KOH, 80 ml of methanol and 55.8 g (0.3 eq) of CE-1095 (P&G CE-1095—Methyl Decanoate) in a 250 ml 3 neck flask equipped with a mechanical top stirrer, thermometer and a reflux condenser was heated at reflux (˜68° C.) with stirring for 2 hours. Next 67.6 g (1 eq) of polydextrose that had been dried in the vacuum oven overnight at 80° C. and 1 g potassium carbonate were added and the heating was continued. Next the methanol removal was started. The temperature remained at 68° C. for about 1 hour and then the reaction mixture began to thicken and the temperature rose to 155° C. The mixture was very thick at this temperature and the mixture solidified upon cooling. After cooling, 118.8 g of a brittle black solid remained which had a hydroxyl value of 591. The solid was not completely soluble in water but slightly soluble in methanol and THF and mostly soluble in methoxyethanol.

### EXAMPLE 14

Polydextrose Ester—Reaction of Polydextrose with Acid Chlorides

### Example 14A

(Theoretical Level of OH Replacement ˜10%)

200 g DMF, 10 g (0.126 eq) pyridine and 33.8 g (0.5 eq) of polydextrose (vacuum dried overnight at 80° C.) was placed in a 1 liter 4 necked flask equipped with a top mechanical stirrer, reflux condenser and an additional funnel. The mixture was heated to 70° C. and during that time all of the polydextrose went into solution. Next 9.5 g (0.05 eq) of decanoyl chloride was added dropwise over a 1.5 hour period and during the addition, the temperature rose to 90° C. but dropped back to 84° C. at the end of this period.

Small aliquots were removed and mixed with different solvents with the following results:
water—no precipitate
ethanol—slight precipitate
acetone—white precipitate that is soluble in water
methanol—no precipitate

The DMF was distilled off under vacuum (temp rose to 95° C. during the distillation). 55.7 g of a gummy residue was left which was washed with 300 ml of ethanol. The solid was filtered leaving about 38.6 g of “wet” product. After vacuum drying, 21.8 g (53%) of product remained which had a hydroxyl value of 725.

### Example 14B

(Theoretical Level of Hydroxyl Replacement ˜30%)

200 g DMF, 15.8 g (0.2 eq) pyridine and 34 g (0.5 eq) of polydextrose (vacuum dried overnight at 80° C.) was placed in a 1 liter 4 necked flask equipped with a top mechanical stirrer, reflux condenser and an additional funnel. The mixture was heated to 70° C. and during that time all of the polydextrose went into solution. Next 28.6 g (0.15 eq) of decanoyl chloride was added dropwise over a 1.0 hour period and during the addition, the temperature rose to 90° C. but dropped back to 85° C. at the end of this period.

Next 300 ml of water was added leading to a gummy precipitate. After cooling the water was decanted away and the gummy solid was washed 2 times with 200 ml of water. The water was decanted away and the gummy solid placed in a vacuum oven at 70° C. and dried. 46.1 g of product resulted (˜81%) yield) which had a hydroxyl value of 427.

### Example 14C

(Theoretical Level of Hydroxyl Replacement ˜40%)

200 g DMF, 19.75 g (0.25 eq) pyridine and 34 g (0.5 eq) of polydextrose (vacuum dried overnight at 80° C.) was placed in a 1 liter 4 necked flask equipped with a top mechanical stirrer, reflux condenser and an additional funnel. The mixture was heated to 70° C. and during that time all of the polydextrose went into solution. Next 38.1 g (0.2 eq) of decanoyl chloride was added dropwise over a 0.75 hour period and during the addition, the temperature rose to 91° C.

Next 400 ml of water was added leading to a gummy precipitate. After cooling in a freezer, the water was decanted away and the gummy solid was washed 2 times with 200 ml of water. The water was decanted away and the dough like solid placed in a vacuum oven at 70° C. and dried. 60.13 g of product resulted (˜140% yield). Apparently, the by-product pyridine hydrochloride was trapped in with the product. The product was washed again with water and dried but still most of the pyridine hydrochloride remained. The solid was then mixed with water and heated to 60° C. and the stickiness seemed to go away. It was filtered and washed again filtered and dried under vacuum. 52.3 g of product resulted (80.7% yield) which had a hydroxyl value of 372.

### Example 14D

(Theoretical Level of Hydroxyl Replacement ˜15%)

200 g DMF, 7.9 g (0.1 eq) pyridine and 34 g (0.5 eq) of polydextrose (vacuum dried overnight at 80° C.) was placed in a 1 liter 4 necked flask equipped with a top mechanical stirrer, reflux condenser and an additional funnel. The mixture was heated to 70° C. and during that time all of the polydextrose went into solution. Next 14.3 g (0.075 eq) of decanoyl chloride was added dropwise over a 0.75 hour period and during the addition, the temperature rose to 95° C. An aliquot was removed and water was added—very little precipitate. Similarly when ethanol was added no precipitate resulted. Since the product does not precipitate readily, the DMF was distilled off under vacuum, keeping the pot temperature below 100° C. during the distillation.

Next 300 ml of acetone was added to the residue. The insoluble material was gummy and difficult to work with. It was also still very hydroscopic. The solid was filtered and dried in the vacuum oven, 38.95 g of solid was obtained which had a hydroxyl value of 483.

### Example 14E

(Theoretical Level of Hydroxyl Replacement ˜20%)

200 g DMF, 9.5 g (0.12 eq) pyridine and 34 g (0.5 eq) of polydextrose (vacuum dried overnight at 80° C.) was placed in a 1 liter 4 necked flask equipped with a top mechanical stirrer, reflux condenser and an additional funnel. The mixture was heated to 70° C. and during that time all of the polydextrose went into solution. Next 19.05 g (0.10 eq) of decanoyl chloride was added dropwise over a 2 hour period and during the addition, the temperature rose to 90° C.

Next 500 ml of water was added and the mixture was cooled in the refrigerator. The liquid was decanted away from the gummy solids and more water (200 ml) was added to wash the product further. The water was decanted away from the gummy solids. The solids were dried in the vacuum oven overnight at 70° C. 27.95 g solids resulted (˜56.6%) yield) which had a hydroxyl value of 529.

### Example 14F

(Theoretical Level of Hydroxyl Replacement ˜30%)

200 g DMF, 15.8 g (0.2 eq) pyridine and 34 g (0.5 eq) of polydextrose (vacuum dried overnight at 80° C.) was placed in a 1 liter 4 necked flask equipped with a top mechanical stirrer, reflux condenser and an additional funnel. The mixture was heated to 70° C. and during that time all of the polydextrose went into solution. Next 29.2 g (0.15 eq) of decanoyl chloride was added dropwise over a 0.25 hour period and during the addition, the temperature rose to 90° C. and heat applied and continued at 90° C. for an additional 2 hours.

Next 300 ml of water was added leading to a gummy precipitate. After cooling the water was decanted away and the gummy solid was washed 2 times with 200 ml of water. The water was decanted away and the gummy solid placed in a vacuum oven at 70° C. and dried. 50.1 g of product resulted (˜87%) yield) which had a hydroxyl value of 434.

### Example 14G

(Theoretical Level of Hydroxyl Replacement ˜40%)

200 g DMF, 39.5 g (0.5 eq) pyridine and 68 g (1.0 eq) of polydextrose (vacuum dried overnight at 80° C.) was placed in a 1 liter 4 necked flask equipped with a top mechanical stirrer, reflux condenser and an additional funnel. The mixture was heated to 70° C. and during that time all of the polydextrose went into solution. Next 76.2 g (0.4 eq) of decanoyl chloride was added dropwise over 15 minutes and next the mixture was to 90° C. and held there for 1 hour.

Next 800 ml of water was added leading to a gummy precipitate. After cooling in a freezer, the water was decanted away and the gummy solid was washed 2 times with 400 ml of water. The water was decanted away and the dough like solid placed in a vacuum oven at 70° C. and dried. 121.7 g of product resulted (˜94% yield) which had a hydroxyl value of 333.

### Example 14H

(Theoretical Level of Hydroxyl Replacement ˜40%)

400 g DMF, 39.5 g (0.5 eq) pyridine and 68 g (1.0 eq) of polydextrose (vacuum dried overnight at 80° C.) was placed in a 1 liter 4 necked flask equipped with a top mechanical stirrer, reflux condenser and an additional funnel. The mixture was heated to 70° C. and during that time all of the polydextrose went into solution. Next 65.1 g (0.4 eq) of octanoyl chloride was added dropwise over 15 minutes and next the mixture was to 90° C. and held there for 1 hour.

Next 800 ml of water was added leading to a gummy precipitate. After cooling in a freezer, the water was decanted away and the gummy solid was washed 2 times with 400 ml of water. The water was decanted away and the dough like solid placed in a vacuum oven at 70° C. and dried. 91.7 g of product resulted (˜77% yield) which had a hydroxyl value of 366.

### Example 14I

(Theoretical Level of Hydroxyl Replacement ˜40%)

400 g DMF, 39.5 g (0.5 eq) pyridine and 68 g (1.0 eq) of polydextrose (vacuum dried overnight at 80° C.) was placed in a 1 liter 4 necked flask equipped with a top mechanical stirrer, reflux condenser and an additional funnel. The mixture was heated to 70° C. and during that time all of the polydextrose went into solution. Next 65.1 g (0.4 eq) of isooctanoyl chloride was added dropwise over 15 minutes and next the mixture was to 90° C. and held there for 1 hour.

Next 800 ml of water was added leading to a gummy precipitate. After cooling in a freezer, the water was decanted away and the gummy solid was washed 2 times with 400 ml of water. The water was decanted away and the dough like solid placed in a vacuum oven at 70° C. and dried. 74.6 g of product resulted (˜63% yield) which had a hydroxyl value of 333.

### Example 14J

(Theoretical Level of Hydroxyl Replacement ˜60%)

400 g DMF, 55.4 g (0.7 eq) pyridine and 68 g (1.0 eq) of polydextrose (vacuum dried overnight at 80° C.) was placed in a 1 liter 4 necked flask equipped with a top mechanical stirrer, reflux condenser and an additional funnel. The mixture was heated to 70° C. and during that time all of the polydextrose went into solution. Next 65.1 g (0.4 eq) of octanoyl chloride was added dropwise over 15 minutes and next the mixture was to 90° C. and held there for 1 hour.

Next 800 ml of water was added leading to a gummy precipitate. After cooling in a freezer, the water was decanted away and the gummy solid was washed 2 times with 400 ml of water. The water was decanted away and the dough like solid placed in a vacuum oven at 70° C. and dried. 135.5 g of product resulted (˜94.3% yield) which had a hydroxyl value of 258.

### Example 14K

(Theoretical Level of Hydroxyl Replacement ˜60%)

400 g DMF, 55.4 g (0.7 eq) pyridine and 68 g (1.0 eq) of polydextrose (vacuum dried overnight at 80° C.) was placed in a 1 liter 4 necked flask equipped with a top mechanical stirrer, reflux condenser and an additional funnel. The mixture was heated to 70° C. and during that time all of the polydextrose went into solution. Next 114.4 g (0.6 eq) of decanoyl chloride was added dropwise over 15 minutes and next the mixture was to 90° C. and held there for 1 hour.

Next 800 ml of water was added leading to a gummy precipitate. After cooling in a freezer, the water was decanted away and the gummy solid was washed 2 times with 400 ml of water. The water was decanted away and the dough like solid placed in a vacuum oven at 70° C. and dried. 157.8 g of product resulted (˜90.3% yield) which had a hydroxyl value of 229.

### EXAMPLE 15

Polydextrose Ester—Reaction of Polydextrose with Vinylneodecanoate

(Theoretical Level of Hydroxyl Replacement ˜50%)

200 g dimethyl sulfoxide (DMSO), 55.4 g (0.7 eq) and 34 g (0.5 eq) of polydextrose (vacuum dried overnight at 80° C.) was placed in a 1 liter 4 necked flask equipped with a top mechanical stirrer, reflux condenser and an additional funnel. The mixture was heated to 90° C. and then 20 g of sodium bicarbonate was added followed by 29.7 (0.15 equivalents) of vinyl neodecanoate over 5 minutes and the mixture was heated for 4 hour. No substantial reaction seemed to have occurred (aliquot addition to water with almost no precipitate) so additional sodium bicarbonate (20 g) was added followed by an additional 19.1 g (0.1 eq) of vinyl neodecanoate. The mixture was gradually heated to 160° C. over a 5 hour period.

After cooling, 600 ml of water was added leading to a gummy precipitate. After cooling in a freezer, the water was decanted away and the gummy solid was washed 2 times with 300 ml of water. The water was decanted away and the dough like solid placed in a vacuum oven at 70° C. and dried. 47.8 g of product resulted (˜66% yield) which had a hydroxyl value of 319.

### EXAMPLE 16

Polydextrose Ether

### Example 16A

A mixture of 344 grams of 95DE liquid corn syrup (244 gram anhydrose dextrose), 158 grams of 1-decanol, and 1.2 gm phosphoric acid was heated under partial vacuum, with stirring, to remove water and create a hot melt. The temperature of the mixture was maintained between 152 to 188° C., with stirring, for 5-20 minutes under partial vacuum. Unreacted decanol forming an oily layer was removed. Upon cooling, approximately 262 grams of a brittle substance, being the derivatized, highly branched polysaccharide was obtained having 9.2 gm residual unreacted glucose and a hydroxyl value of 674 (equivalent wt=83).

### Example 16B

A mixture of 344 grams of 95DE liquid corn syrup (244 gram anhydrose dextrose), 186 grams of 1-dodecanol, and 1.2 gm phosphoric acid was heated under partial vacuum, with stirring, to remove water and create a hot melt. The temperature of the mixture was maintained between 152 to 188° C., with stirring, for 5-20 minutes under partial vacuum. Unreacted decanol forming an oily layer was removed. Upon cooling, approximately 235 grams of a brittle substance, being the derivatized, highly branched polysaccharide was obtained having 9.2 gm residual unreacted glucose and a hydroxyl value of 687 (equivalent wt=82).

### Example 16C

A mixture of 344 grams of 95DE liquid corn syrup (244 gram anhydrose dextrose), 214 grams of 1-tetradecanol, and 1.2 gm phosphoric acid was heated under partial vacuum, with stirring, to remove water and create a hot melt. The temperature of the mixture was maintained between 152 to 188° C., with stirring, for 5-20 minutes under partial vacuum. Unreacted tetradecanol forming an oily layer was removed. Upon cooling, approximately 289 grams of a brittle substance, being the derivatized, highly branched polysaccharide was obtained having 12.4 gm residual unreacted glucose and a hydroxyl value of 597 (equivalent wt=94).

### Example 16D

A mixture of 344 grams of 95DE liquid corn syrup (244 gram anhydrose dextrose), 214 grams of 1-hexadecanol, and 1.2 gm phosphoric acid was heated under partial vacuum, with stirring, to remove water and create a hot melt. The temperature of the mixture was maintained between 152 to 188° C., with stirring, for 5-20 minutes under partial vacuum. Unreacted tetradecanol forming an oily layer was removed. Upon cooling, approximately 274 grams of a brittle substance, being the derivatized, highly branched polysaccharide was obtained having 14.8 gm residual unreacted glucose and a hydroxyl value of 652 (equivalent wt=86).

### EXAMPLE 17

Polydextrose Ester Solubility

The solubility of the polydextroses prepared in examples 14 and 15 where evaluated in different solvents starting with the very polar solvent—water to the very non polar solvent—methyl t-butyl ether. The polarity was reflected by a term known as the solubility parameter (δ), a value which for the very polar water is 23.4° and decreases as one moves through the Table to the very non polar methyl t-butyl ether, a low number of 7.4. A polymer with a solubility parameter similar to the solvent will dissolve in it. Components with dramatic differences in solubility parameters, for example water and oil—will not dissolve or mix.

15.0 g of the derivatized highly branched polysaccharide according to Examples 14 and 15 as indicated in Table 2 were added to 85.0 g of solvent (15% concentration). The clarity and level of undissolved solids were noted. The specific solubility parameter of the solvent in which the solution was completely clear was recorded as the approximate solubility of the derivatized highly branched polysaccharide. If undissolved solids remained in room temperature (rt) the mixture was heated where after the mix was again noted for any insolubility.

TABLE 2

| | | Solubility of the Polydextrose Derivatives | | | | | | |
|---|---|---|---|---|---|---|---|---|
| | Solubility | 14A | 14D | 14E | 14B | 14C | 15 | 14F |
| Example No. | Parameter | 10% | 15% | 20% | 30% | 40% | 30% | 50% |
| Solvent | δ | sub* | sub* | sub* | sub* | sub* | sub* | sub** |
| water | 23,4 | sol (rt) | sol (rt) | insol | insol | insol | insol | insol |
| EG | 16,3 | sol (rt) | sol (rt) | sl sol | | | part sol | part sol |
| | | | | (heat) | | | (rt) | (rt) |
| methanol | 14,5 | sol (rt) | sol (rt) | sol (rt) | sol (rt) | sol (rt) | sol (rt) | sol (rt) |
| EG monomethyl | 12,1 | sol (rt) | sol (rt) | sol (rt) | sol (rt) | sol (rt) | sol (rt) | sol (rt) |
| ether | | | | | | | | |
| EG monopropyl | 11,1 | insol | sol (heat) | sol (rt) | sol (rt) | sol (rt) | sol (rt) | sol (rt) |
| ether | | | | | | | | |
| DPG monomethyl | 10,2 | | | | | sol (rt) | | |
| ether | | | | | | | | |
| acetone | 9,9 | insol | insol | sl sol | sol (rt) | sol (rt) | | |
| | | | | (heat) | | | | |
| DPG-n-propyl ether | 9,6 | | | | | | | sol (rt) |
| DPG-n-butyl ether | 9,5 | insol | insol | sol (heat) | sol (heat) | sol (rt) | sol (heat) | |
| toluene | 8,9 | | | | | | | |
| ethylene dimethyl | 8,6 | | | | sol (rt) | | sol (rt) | sol (rt) |
| ether | | | | | | | | |
| MTBE | 7,4 | insol | | insol | sol (heat) | sol (rt) | sol (heat) | sol (rt) |

*=acid chloride reaction
**=vinyl ester transesterification
EG=ethylene glycol
DPG=diproplyleneglycol
MTBE=methyl-t-butylether

Table 2 shows how the hydrophilicity decreases and therefore the solubility in less polar solvents increases as the degree of substitution increases. When more ester groups are introduced the solubility parameter of the polydextrose derivatives lowered and when the solubility parameter is below 14, preferably below. 12 the modified polydextrose dissolved in solvents in which underivatized and less substituted polydextrose is insoluble. Therefore as the substitution increased, the polydextrose derivatives became more soluble in the very non polar solvent, MTBE.

### EXAMPLES 18-27

Examples 18-27 illustrate the use of the present derivatized highly branched polysaccharide or copolymer polyols, in a typical isocyanate based high resilient (HR) based foam. In each Example, the isocyanate based foam was prepared by the pre-blending of all resin ingredients including polyols, copolymer polyols (if used), catalysts, water, and surfactants as well as the derivatized highly branched polysaccharide of interest (if used). The isocyanate was excluded from the mixture. The resin blend and isocyanate were then mixed in a free rise cup at an isocyanate index as indicated in tables 3 and 4 using a high speed dispersator. The foam was allowed to rise freely at room temperature and the cups were moved to an oven (50° C.) for 1 hour where after the properties of interest were measured. The methodology will be referred to in Examples 18-27 as the General Procedure.

In Examples 18-27, the following materials are used:

E837, base polyol, commercially available from Lyondell;

E850, a 43% solids content copolymer (SAN) polyol, commercially available from Lyondell;

D-PDX, polydextrose derivatives produced according to examples 14 C, 14 J, 14 K and 15 above;

DEAO LF, diethanol amine, a crosslinking agent commercially available from Air Products; Water, indirect blowing agent;

Dabco 33LV, a gelation catalyst, commercially available from Air Products;

Niax A-1, a blowing catalyst, commercially available from Witco;

Niax L-3184 a silicon surfactant manufactured by GE

Lupranate T80, isocyanate (toluene diisocyanate—TDI), commercially available from BASF.

Unless otherwise stated, all parts reported in Examples 18-27 are in parts by weight. In Examples 18-27, isocyanate based foams based on the formulations shown in Table 3 and 4 are produced using the General procedure referred to above. The polydextrose derivatives of Examples 22-27 were produced according to Example 14 C (Examples 22 and 23), Example 15 (Examples 24 and 25) and Example 14 J and 14 K (Examples 26 and 27).

The results of physical property testing for each foam was the density and Compressive Load Deflection (CLD) at 50% deflection, measured pursuant to ASTM D3574 Test C, which is a good screening test for small foam samples. The CLD values are given in pounds per square inch (psi). The force in pounds needed to compress the sample was recorded and the result are reported in psi by dividing the force by the surface area of the sample. The CLD determination was run at 50% compression. Samples with nominal dimensions of 2″×2″×1″ were prepared.

TABLE 3
Control foams

| | Examples | | | | | | | |
|---|---|---|---|---|---|---|---|---|
| Ingredient | 18 A | 18 B | 19 A | 19 B | 20 A | 20 B | 21 A | 21 B |
| Hyperlite E 863 | 90 | 90 | 80 | 80 | 60 | 60 | 40 | 40 |
| Hyperlite E 850 | 10 | 10 | 20 | 20 | 40 | 40 | 60 | 60 |
| D-PDX | | | | | | | | |
| DEOA LF | 1.6 | 1.6 | 1.6 | 1.6 | 1.6 | 1.6 | 1.6 | 1.6 |
| water | 3.93 | 3.93 | 3.93 | 3.93 | 3.93 | 3.93 | 3.93 | 3.93 |
| Dabco 33LV | 0.33 | 0.33 | 0.33 | 0.33 | 0.33 | 0.33 | 0.33 | 0.33 |
| Niax A-1 | 0.08 | 0.08 | 0.08 | 0.08 | 0.08 | 0.08 | 0.08 | 0.08 |
| Niax L-3184 | 1 | 1 | 1 | 1 | 1 | 1 | 1 | 1 |
| Total Resin | 106.94 | 106.94 | 106.94 | 106.94 | 106.44 | 106.44 | 106.44 | 106.44 |
| TDI 80 | 46.65 | 46.65 | 46.48 | 46.48 | 46.13 | 46.13 | 45.79 | 45.79 |
| Index | 1.0 | 1.0 | 1.0 | 1.0 | 1.0 | 1.0 | 1.0 | 1.0 |
| Mix | 5 | 5 | 5 | 5 | 5 | 5 | 5 | 5 |
| Initiation | 10 | 10 | 10 | 10 | 10 | 10 | 10 | 10 |
| Gel | 80 | 80 | 80 | 80 | 80 | 80 | 75 | 75 |
| Rise | 80 | 80 | 80 | 80 | 80 | 80 | 75 | 75 |
| Density (pcf) | 1.97 | 1.99 | 1.97 | 2.09 | 1.73 | 1.77 | 1.74 | 1.80 |
| 50% CLD (psi) | 0.42 | 0.41 | 0.50 | 0.53 | 0.59 | 0.57 | 0.75 | 0.83 |

In examples 18-21, isocyanate based foams were prepared in the absence of any derivatized highly branched polysaccharide. Copolymer polyol was used to increase foam hardness. Thus, it will be appreciated that Examples 18-21 are provided for comparative purposes only and are outside the scope of the present invention.

The isocyanate based foams were formulated with a H₂O concentration of 3.93% resulting in an approximate foam core density of 1.7-2.09 pcf. In order to compare the CLD's of the different foams, one needs to have comparable densities. Two pairs of polymer polyol controls of Example 18 and 19 all have a nominal 2.0 lb/ft³ density. The samples with 20% POP (˜8.6% solids) have a 50% CLD of about 0.52 psi versus 0.41 for the 10% POP (˜4.3% solids). The higher solids POP foams of Example 20 [17.2%] and 21 [25.8%]) show increased 50% CLD (0.58 and 0.79 psi respectively) even at a density slightly below 1.8 lb/ft³.

TABLE 4

| | Examples | | | | | | | | | |
|---|---|---|---|---|---|---|---|---|---|---|
| Ingredient | 22 A | 22 B | 23 A | 23 B | 24 A | 24 B | 25 A | 25 B | 26 | 27 |
| Hyperlite E 863 | 95 | 95 | 97 | 97 | 95 | 95 | 97.5 | 97.5 | 95 | 95 |
| Hyperlite E 850 | | | | | | | | | | |
| D-PDX | 5 | 5 | 3 | 3 | 5 | 5 | 2.5 | 2.5 | 5 | 5 |
| DEOA LE | 2.4 | 2.4 | | | 2 | 2 | 2 | 2 | 2.4 | 2.4 |
| water | 3.93 | 3.93 | 3.93 | 3.93 | 3.93 | 3.93 | 3.93 | 3.93 | 3.93 | 3.93 |
| Dabco 33LV | 0.33 | 0.33 | 0.33 | 0.33 | 0.33 | 0.33 | 0.33 | 0.33 | 0.33 | 0.33 |
| Niax A-1 | 0.08 | 0.08 | 0.08 | 0.08 | 0.08 | 0.08 | 0.08 | 0.08 | 0.08 | 0.08 |
| Dabcon 5164 | 1 | 1 | 1 | 1 | 1 | 1 | 1 | 1 | | |
| Niax 3184 | | | | | 3 | 3 | 3 | 3 | 1.4 | 1.4 |
| TDI 80 | 46.3 | 46.3 | 46.0 | 46.0 | 49.2 | 49.2 | 49.2 | 49.2 | 50.2 | 50.45 |
| Index | 0.86 | 0.86 | 0.91 | 0.91 | 0.98 | 0.98 | 1.0 | 1.0 | 1 | 1 |
| Mix | 5 | 5 | 5 | 5 | 5 | 5 | 5 | 5 | 5 | 5 |
| Initiation | 10 | 10 | 12 | 12 | 10 | 10 | | | 11 | 14 |
| Gel | 75 | 75 | 75 | 75 | 40 | 40 | 40 | 40 | 60 | 105 |
| Rise | 60 | 60 | 75 | 75 | 40 | 40 | 35 | 35 | 75 | 90 |
| Density (pcf) | 1.97 | 1.88 | 2.27 | 2.34 | 2.02 | 2.24 | 2.29 | 2.22 | | |
| 50% CLD (psi) | 0.70 | 0.57 | 0.83 | 0.95 | 0.66 | 0.84 | 0.60 | 0.31 | | |

The Formulation of Example 22 has an average density of 1.95 lb/ft³ and an average 50% CLD of ˜0.64 psi. This CLD is higher than either of the comparable density POP foams with either 4.3 or 8.6% solids, although a smaller amount of derivatized highly branched polydextrose is used. Similarly the formulation of Example 24 has a slightly higher average density of 2.13 lb/ft³ and an average 50% CLD of 0.75. Another direct comparison of two different polydextrose dendrimers can be made with the formulation of example 24 A and of example 22 A (˜1.97 lb/ft³). The lower density of the formulation of example 22 A has only a slightly higher 50% CLD (0.70 psi) than that of the formulation of example 24 A (0.66 psi).

Moreover, the formulations of example 24B and 25A may be compared since their density is almost the same. The CLD value is lower for 25A which indicates that the hardness is improved with the increase of the amount of derivatized highly branched polysaccharide.

While this invention has been described with reference to illustrative embodiments and Examples, the description is not intended to be construed in a limiting sense. For example, while esterification/acid derivatisation and ring opening techniques are used in some of the Examples to produce embodiments of the novel derivatized highly branched polysaccharide, other derivatisation techniques such as transesterification, polyaddition reactions, free radical polymerisation and the like can be used. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. A highly branched polysaccharide of randomly bonded glucopyranose units, having an average number of 10-100 glucose residues wherein said polysaccharide has an active hydrogen functionality of at least 15 and is derivatized to provide a hydrophobicity which renders it compatible with a polyether polyol with which the underivatized polysaccharide is incompatible.

2. The highly branched polysaccharide of claim 1, wherein said derivatized highly branched polysaccharide has an active hydrogen functionality of 15 to 70.

3. The highly branched polysaccharide of claim 2, wherein said derivatized highly branched polysaccharide has an active hydrogen functionality of 20 to 60.

4. The highly branched polysaccharide of claim 2, wherein said derivatized highly branched polysaccharide has an active hydrogen functionality of 30 to 50.

5. The highly branched polysaccharide of claim 1, wherein said derivatized highly branched polysaccharide has a solubility parameter below 14.

6. The highly branched polysaccharide of claim 1, wherein said derivatized highly branched polysaccharide has a solubility parameter below 12.

7. The highly branched polysaccharide of claim 1, wherein said hydrophobicity of said polysaccharide is sufficient to cause a mixture of said polysaccharide and said polyether polyol with which the underivatized polysaccharide is incompatible, said compatibility indicating mixture comprising at least 5% (w/w) of said polysaccharide, to form a uniform liquid at 23° C.

8. The highly branched polysaccharide of claim 7, wherein said compatibility indicating mixture comprising 5 to 50% of the polysaccharide forms a uniform liquid at 23° C.

9. The highly branched polysaccharide of claim 7, wherein said compatibility indicating mixture comprising 5 to 40% of the polysaccharide forms a uniform liquid at 23° C.

10. The highly branched polysaccharide of claim 7, wherein said compatibility indicating mixture comprising 5 to 30% of the polysaccharide forms a uniform liquid at 23° C.

11. The highly branched polysaccharide of claim 1, wherein said polysaccharide is derivatized by a chemical reaction with a hydrophobic organic compound comprising 6-20 carbon atoms selected from aliphatic and aromatic carbon atoms and combinations thereof.

12. The highly branched polysaccharide of claim 11, wherein said organic compound is selected from C₆-C₁₂ carboxylic acids and C₆-C₁₂ organic alcohols.

13. The highly branched polysaccharide of claim 12, wherein said carboxylic acid is selected from fatty acids or reactive derivatives thereof.

14. The highly branched polysaccharide of claim 13, wherein the weight of fatty acid residues is 5 to 50% based on the weight of the derivatized highly branched polysaccharide.

15. The highly branched polysaccharide of claim 14, wherein the weight of fatty acid residues is 15 to 40% based on the weight of the derivatized highly branched polysaccharide.

16. The highly branched polysaccharide of claim 1, wherein said polyether polyol with which the underivatized polysaccharide is incompatible comprises at least 70% polypropylene oxide.

17. The highly branched polysaccharide of claim 1, wherein said polyether polyol has a hydroxyl value of at most 60 mg KOH/g.

18. The highly branched polysaccharide of claim 17, wherein said polyether polyol has a hydroxyl value of 15 to 55 mg KOH/g.

19. The highly branched polysaccharide of claim 17, wherein said polyether polyol has a hydroxyl value of 28 to 36 mg KOH/g.

20. The highly branched polysaccharide of claim 1, wherein said polyether polyol has a molecular weight in the range of from 200 to 12,000.

21. The highly branched polysaccharide of claim 20, wherein said polyether polyol has a molecular weight in the range of from 2,000 to 7,000.

22. The highly branched polysaccharide of claim 20, wherein said polyether polyol has a molecular weight in the range of from 2,000 to 6,000.

23. The highly branched polysaccharide of claim 1, wherein said highly branched polysaccharide consists of randomly cross-linked glucose units with all types of glycosidic bonds, containing minor amounts of a bound sugar alcohol and an acid, and having an average molecular weight between about 1,500 and 18,000.

24. The highly branched polysaccharide of claim 23, wherein said highly branched polysaccharide has predominantly 1,6 glycosidic bonds.

25. The highly branched polysaccharide of claim 23, wherein said highly branched polysaccharide is a polycondensation product of glucose, maltose or other simple sugars or glucose-containing material such as hydrolyzed starch and a sugar alcohol in the presence of a carboxylic acid.

26. The highly branched polysaccharide of claim 25, wherein said sugar alcohols are selected from the group consisting of sorbitol, glycerol, erythritol, xylitol, mannitol, galactitol or mixtures thereof, at a level of 5-20% by weight of the underivatized polysaccharide.

27. The highly branched polysaccharide of claim 26, wherein said sugar alcohols are selected from the group consisting of sorbitol, glycerol, erythritol, xylitol, mannitol, galactitol or mixtures thereof, at a level of 5-15% by weight of the underivatized polysaccharide.

28. The highly branched polysaccharide of claim 26, wherein said sugar alcohols are selected from the group consisting of sorbitol, glycerol, erythritol, xylitol, mannitol, galactitol or mixtures thereof, at a level of 8-12% by weight of the underivatized polysaccharide.

29. The highly branched polysaccharide of claim 26, wherein said polysaccharide is a polycondensation product of glucose, sorbitol and citric acid.

30. The highly branched polysaccharide of claim 26, wherein said polysaccharide is a polydextrose.

31. The highly branched polysaccharide of claim 23, wherein said polysaccharide is purified by a process selected from fractionation, extraction, neutralization, purification by chromatography, filtration, enzyme treatment, carbon treatment and hydrogenation.

32. The highly branched polysaccharide of claim 1, wherein said polysaccharide has predominantly beta-1,4 linkages and a varying number of glucose residues which are hydrolysed from starch to form dextrins and subsequently linked to form branched structures.

33. The highly branched polysaccharide of claim 32, wherein said polysaccharide is pyroconverted starch.

34. The highly branched polysaccharide of claim 1, wherein said polysaccharide is a polydextrose having an active hydrogen functionality of at least 15, derivatized with a C₈₋₁₂-fatty acid to provide a hydrophobicity which renders it compatible with a polyether polyol with which the underivatized polydextrose is incompatible.

35. A mix for the production of a polyurethane comprising a mixture of a polyether polyol and a highly branched polysaccharide of randomly bonded glucopyranose units, having an average number of 10-100 glucose residues, wherein said polysaccharide has an active hydrogen functionality of at least 15 and is derivatized to provide a hydrophobicity which renders it compatible with said polyether polyol with which the underivatized polysaccharide is incompatible.

36. The mix of claim 35, wherein said polyurethane is flexible polyurethane foam.

37. The mix of claim 35, wherein said mix comprises 1 to 50% by weight of said polysaccharide.

38. The mix of claim 37, wherein said mix comprises 5 to 20% by weight of said polysaccharide.

39. The mix of claim 37, wherein said mix comprises 10 to 15% by weight of said polysaccharide.

40. The mix of claim 35, wherein said derivatized highly branched polysaccharide has an active hydrogen functionality of 15 to 70.

41. The mix of claim 40, wherein said derivatized highly branched polysaccharide has an active hydrogen functionality of 20 to 60.

42. The mix of claim 40, wherein said derivatized highly branched polysaccharide has an active hydrogen functionality of 30 to 50.

43. The mix of claim 35, wherein said derivatized highly branched polysaccharide has a solubility parameter below 14.

44. The mix of claim 35, wherein said derivatized highly branched polysaccharide has a solubility parameter below 12.

45. The mix of claim 35, wherein said hydrophobicity of said polysaccharide is sufficient to cause a mixture of said polysaccharide and said polyether polyol with which the underivatized polysaccharide is incompatible, said compatibility indicating mixture comprising at least 5% (w/w) of said polysaccharide to form a uniform liquid at 23° C.

46. The mix of claim 45, wherein said compatibility indicating mixture comprising 5 to 50% of the polysaccharide forms a uniform liquid at 23° C.

47. The mix of claim 46, wherein said compatibility indicating mixture comprising 5 to 40% of the polysaccharide forms a uniform liquid at 23° C.

48. The mix of claim 46, wherein said compatibility indicating mixture comprising 5 to 30% of the polysaccharide forms a uniform liquid at 23° C.

49. The mix of claim 35, wherein said polysaccharide is derivatized by a chemical reaction with an organic compound comprising 6-20 carbon atoms selected from aliphatic aromatic carbon atoms and combinations thereof.

50. The mix of claim 49, wherein said organic compound is selected from the group consisting of C₆-C₁₂ carboxylic acids and C₆-C₁₂ organic alcohols.

51. The mix of claim 50, wherein said carboxylic acid is selected from the group consisting of fatty acids or reactive derivatives thereof.

52. The mix of claim 51 wherein the weight of fatty acid residues is 5 to 50% based on the weight of the derivatized highly branched polysaccharide.

53. The mix of claim 52, wherein the weight of fatty acid residues is 15 to 40% based on the weight of the derivatized highly branched polysaccharide.

54. The mix of claim 35, wherein said polyether polyol with which the underivatized polysaccharide is incompatible comprises at least 70% polypropylene oxide.

55. The mix of claim 35, wherein said polyether polyol has a hydroxyl value of at most 60 mg KOH/g.

56. The mix of claim 55, wherein said polyether polyol has a hydroxyl value of 15 to 55 mg KOH/g.

57. The mix of claim 55, wherein said polyether polyol has a hydroxyl value of 28 to 36 mg KOH/g

58. The mix of claim 35, wherein said polyether polyol has a molecular weight in the range of from 200 to 12,000.

59. The mix of claim 58, wherein said polyether polyol has a molecular weight in the range of from 2,000 to 7,000.

60. The mix of claim 35, wherein said mix further comprises at least one catalyst and at least one surfactant.

61. The mix of claim 60, wherein said catalyst is selected from the group consisting of tertiary amines, metallic salts and mixtures thereof.

62. The mix of claim 60, Wherein said surfactant is a silicone surfactant.

63. The mix of claim 35, wherein said mix further comprises at least one blowing agent selected from the group consisting of water, non-water blowing agents, liquid carbon dioxide and combinations thereof.

64. The mix of claim 63, wherein said blowing agent is water.

65. The mix of claim 63, wherein said blowing agent is a low-boiling organic liquid.

66. The mix of claim 35, wherein said polysaccharide is a polydextrose having an active hydrogen functionality of at least 15, derivatized with a C₈₋₁₂-fatty acid to provide a hydrophobicity which renders it compatible with a polyether polyol with which the underivatized polydextrose is incompatible.
